(19) United States
(12) Patent Application Publication
(10) Pub. No.: US 2016/0009229 A1
(43) Pub. Date: Jan. 14, 2016

(54) MODULAR DEVICE ENCLOSURE SWIVEL USE ATTACHMENT SYSTEM

(71) Applicant: Bruce Max Davis, Chicago, IL (US)

(72) Inventor: Bruce Max Davis, Chicago, IL (US)

(21) Appl. No.: 14/764,050

(22) PCT Filed: Feb. 14, 2014
(86) PCT No.: PCT/US14/16380

§ 371 Date: Jul. 28, 2015

Related U.S. Application Data
(60) Provisional application No. 61/849,672, filed on Feb. 1, 2013.
(60) Provisional application No. 61/850,063, filed on Feb. 8, 2013.

(51) Int. Cl. B60R 11/02; A45F 5/00

(52) U.S. Cl. CPC B60R 11/0241; B60R 11/0258; A45F 5/00; B60R 2011/001

(57) ABSTRACT

A modular mobile device enclosure and multi-part system or kit for purposes of providing functionality of mobile devices while embedded within or upon clothing or objects comprising a connectable by swivel snap modular device enclosure that couples with the opposing connectable swivel snap track, swivel snap pin or other swivel snap connection whereas the device is accessed via a snap and swivel motion from wherever placed by the user. In cases where a swivel motion may not be required to access the device, the system or kit by default is a secure connection between the enclosure, track, object or harness.

### TECHNICAL FIELD

Modular Device Enclosure Swivel Use Attachment System, the invention relates to functional clothing accessories. The invention enables users to embed electronic devices within clothing or upon objects whereas the user may access the device via a snap and swivel motion which requires a two part system of attachment—the male and female swivel fastener. The male and female fasteners are strategically applied to the device enclosure, fabric tracks, swivel clips, swivel pins and other snap vehicles in a way that facilitates multiple swivel options for use while mounted wherever the user chooses to mount the system's modular device enclosure. The modular device enclosure is designed to facilitate usage of the device while contained within the modular enclosure and while attached to wherever the user placed it using a snap and swivel motion. The modular enclosure may also be used as a wallet by design.

### BACKGROUND OF THE ART

Electronic devices are quickly becoming items that people must have near at all times. Prior art addresses some of the issues related to this modern day phenomenon however, this, invention provides multiple novel options for functionality and placement as a user interfaces with their devices.

U.S. Pat. No. 2012/0186000 issued to Raviv is typical of a stationary pocket for touch screen devices. 86000 is specific to touch screen devices and necessitates supports and channels within clothing. By contrast, the present invention facilitates any electronic device whether it is a touch screen or not, and the modular enclosure may be placed wherever the user chooses without any need for clothing supports or channels.

U.S. Pat. No. 2012/0054939 issued to Chow is one more example of a static device pocket that may not be placed on demand wherever a user may desire as 54939 is permanently fixed. By contrast, the present invention is modular and able to provide functionality from multiple placements while the device is still in the modular enclosure and attached to clothing and/or object and accessed via snap and swivel motions.

### DISCLOSURE OF THE INVENTION

A primary objective of the invention is to enable users to place the modular device enclosure wherever it may suit their needs at any particular time and place.

Another objective of the invention, is to provide users with a secure snap and swivel method of attaching the modular device enclosure within or upon clothing or upon objects such as a wall, automobile dashboard, automobile steering wheel, seat or door.

Another objective of the invention is to provide users with fast and safe access to their devices from multiple placements and swivel positions.

Another objective of the invention is to provide users the convenience of press on fabric tracks with swivel points that become semi-permanent and washable once placed within or upon clothing.

Another objective of the invention is to provide users a way to attach the modular device enclosure to purses, bags, briefcases, carryalls and other containers in a way that enables fast access via snap and swivel motions

Another objective of the invention is to provide users with accessories that compliment the art such as modular enclosure stabilizers, belt swivel clips, swivel pins and wristlets.

Another objective of the invention is to provide users a wallet option to keep IDs, cash and credit cards safe, secure and near within the modular enclosure.

Another objective of the invention is to provide users a way to workout and participate in physical activities while wearing the modular enclosure thereby providing fast and safe access to their devices while protecting valuables at the same time.

The present invention meets the above objectives and represents a viable solution to the prior art's shortcomings relative to this invention and this invention's purpose.

### BEST MODUS OPERANDI

### Summary Description

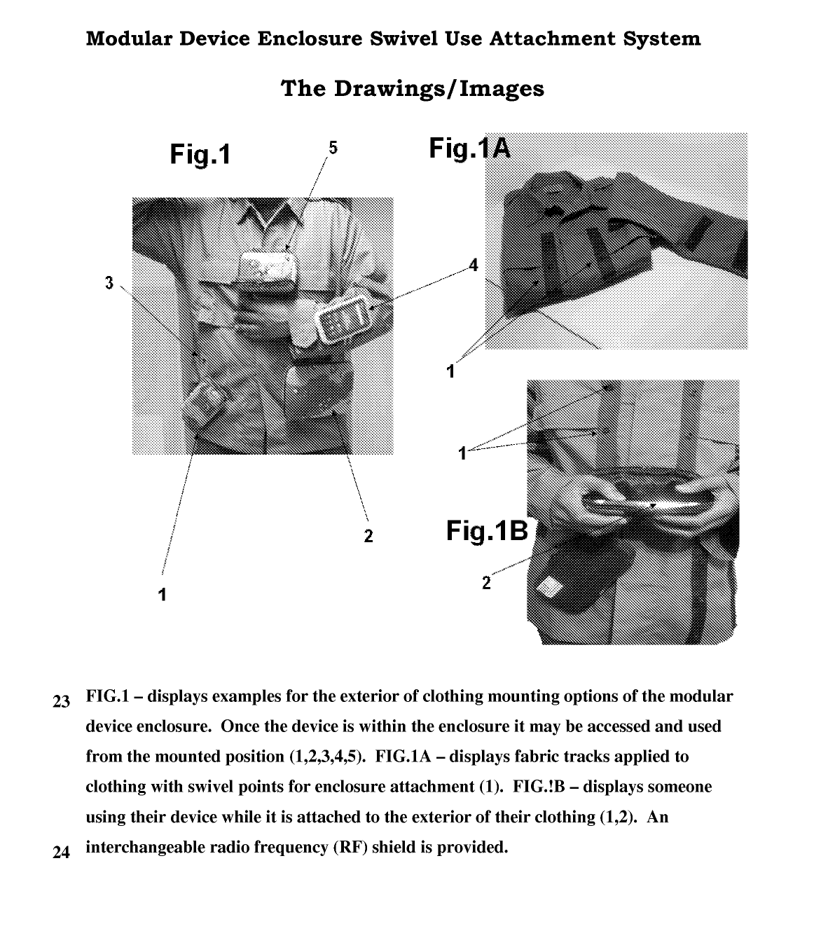

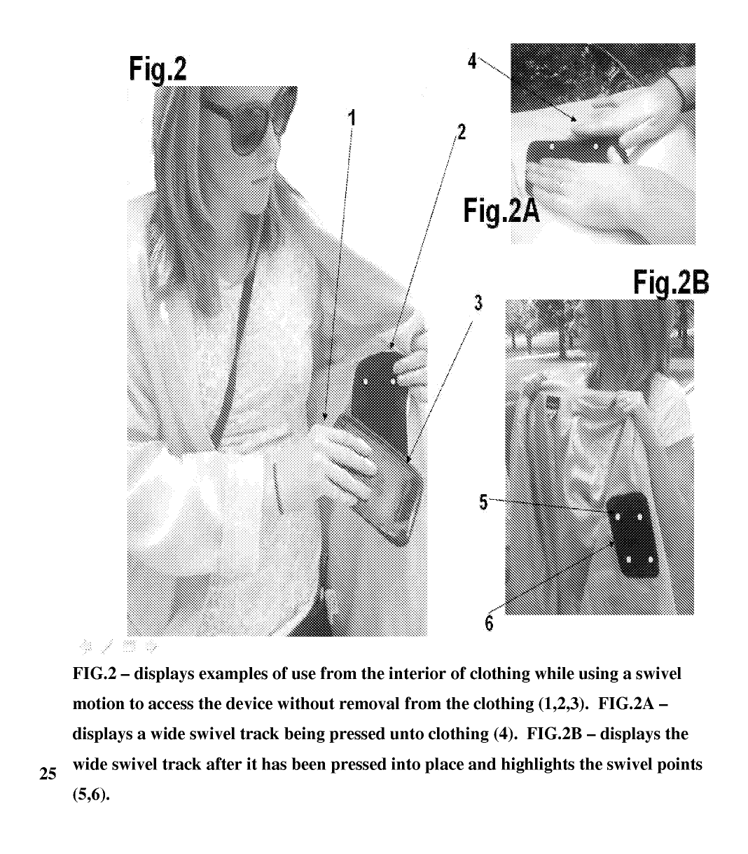

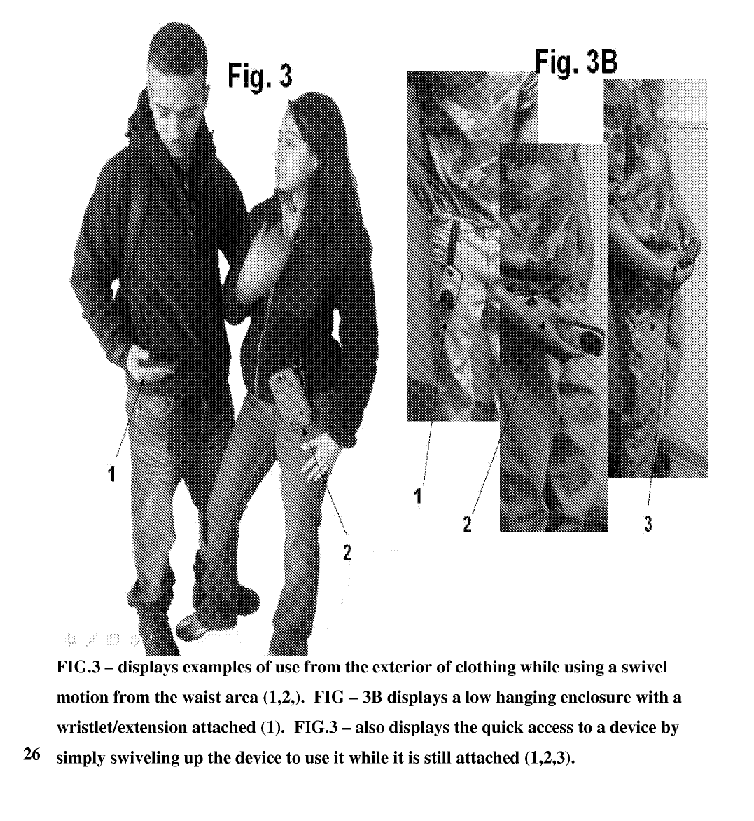

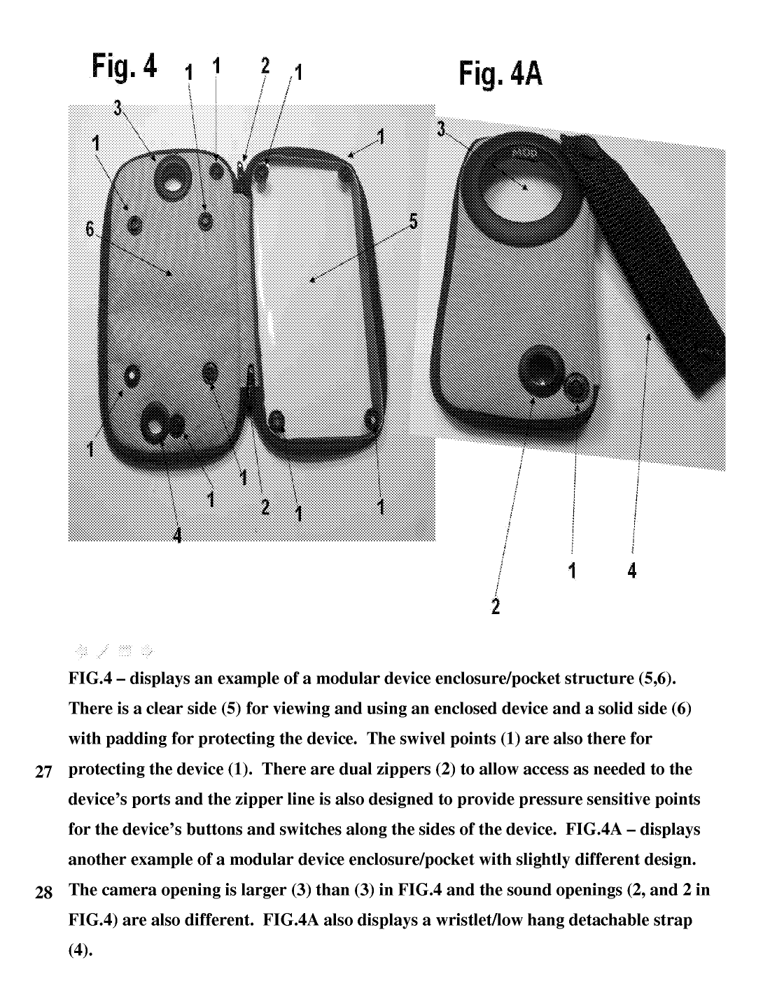

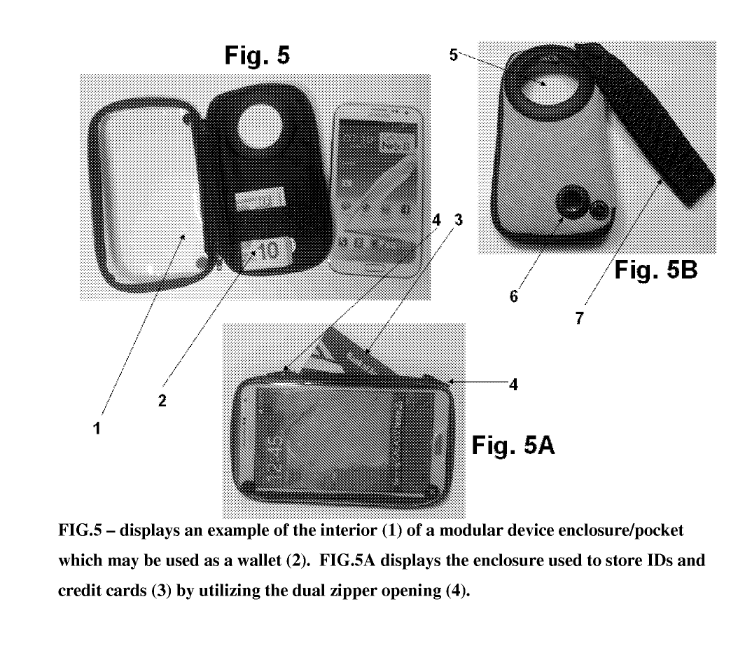

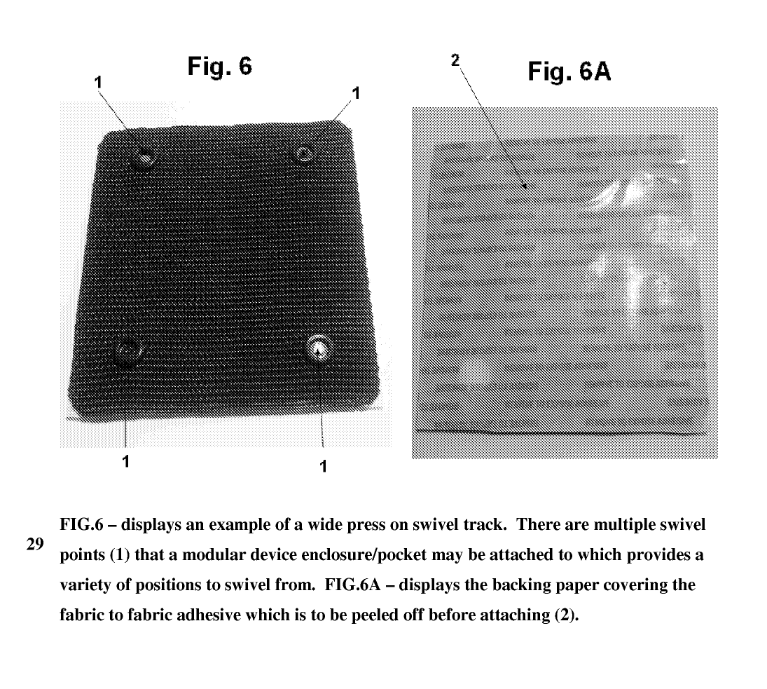

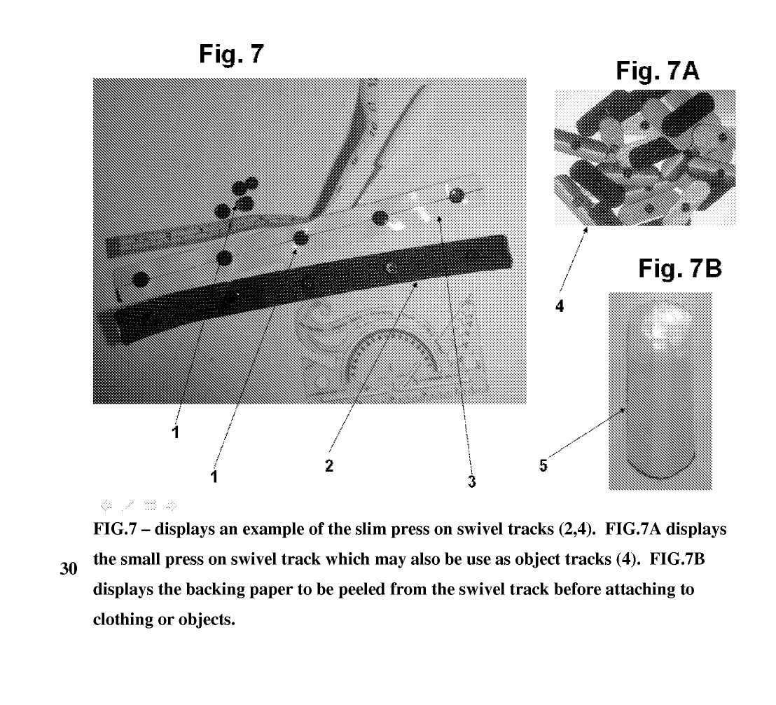

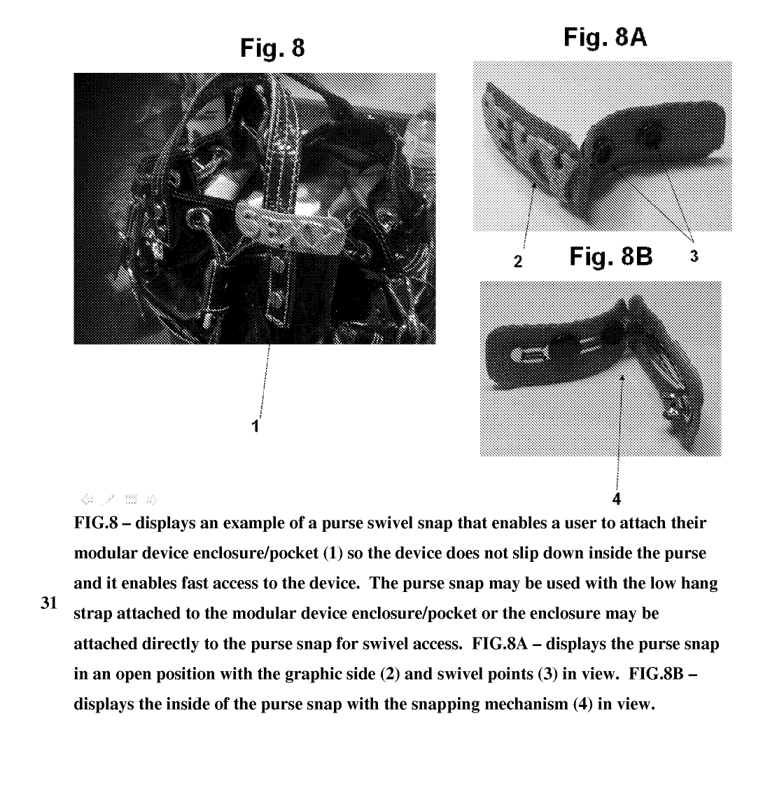

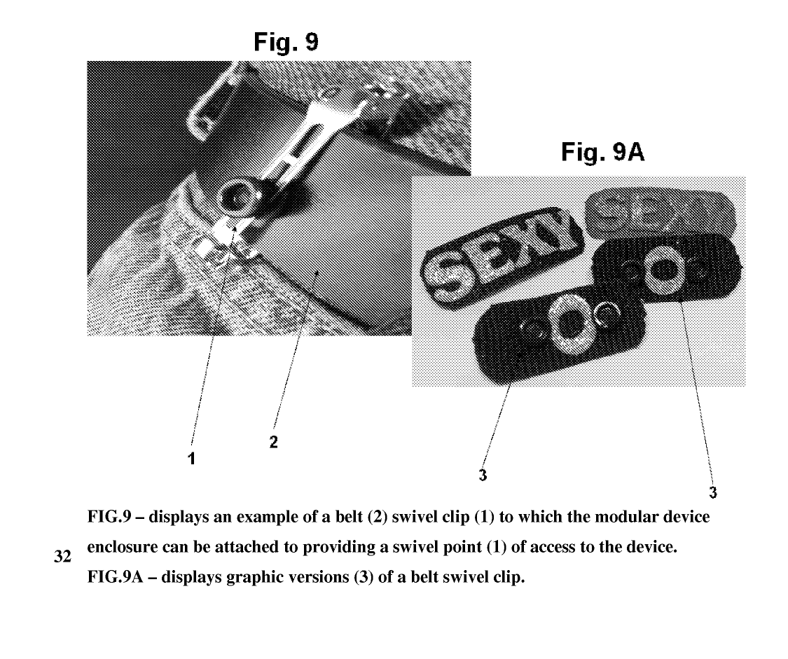

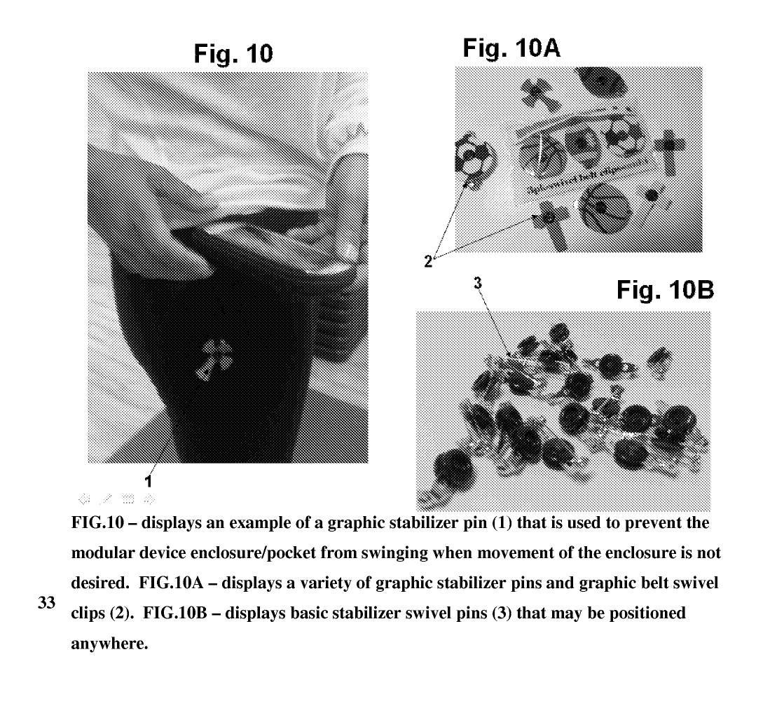

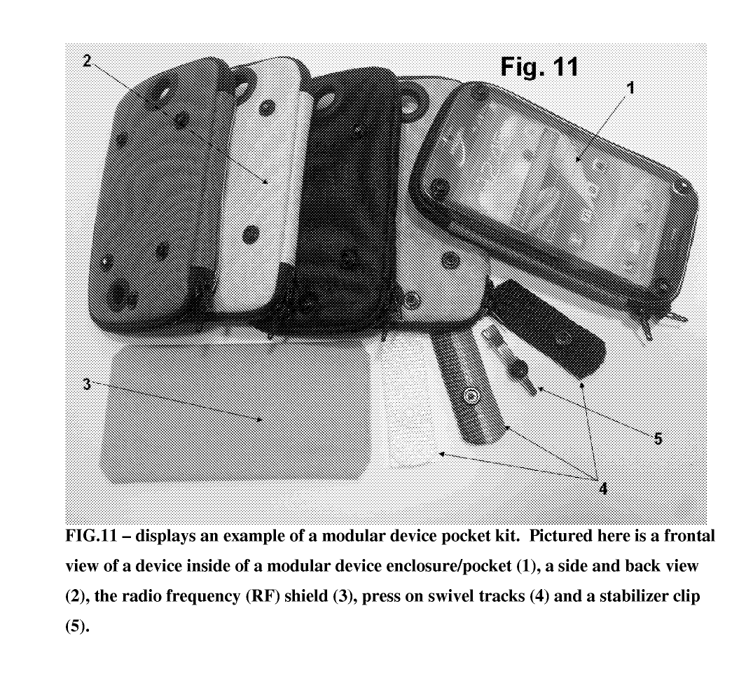

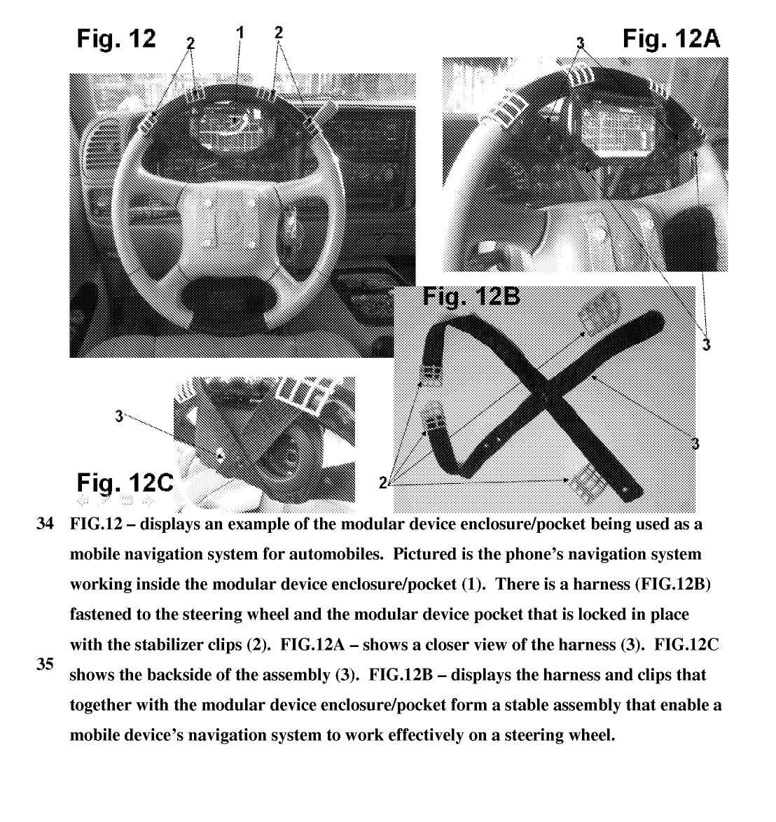

A primary objective of the invention is to enable users to place the modular device enclosure wherever it may suit their needs at any particular time and place. The invention shall be made available as a system or kit that has multiple working parts that together meet the primary objective of functional mobility and flexibility. Also, the system/kit shall have add-on accessories that enhance the utility of the art and these accessories may or may not be stand alone applications of the invention. See FIGS. 1-12.

### INDUSTRY EXPLOITATION

### Applications

There are over 6 billion mobile devices in use throughout the world today. This invention has numerous applications from functional wearable, to home, office and automobile uses. Because the present invention facilitates fast and safe access to one's mobile device there are many industry applications:
Workout clothing accessory
Sports Wear accessory
Casual Wear accessory
Jacket and Coat accessory
Disabled person's accessory
Law enforcement uses
Military uses
Automobile uses
On object uses

What is claimed is: (refer to prior art in “the description” pg. 1, sect 5,6)

1. a multi-part system or kit for purposes of providing functionality of mobile devices while embedded within or upon clothing or objects comprising a connectable by swivel snap modular device enclosure that couples with the opposing connectable swivel snap track, swivel snap pin or other swivel snap connection whereas the device is accessed via a snap and swivel motion.

2. a system or kit component; press on fabric tracks containing the snap swivel points that adhere to other fabrics in a semi-permanent and washable bond that connect with the opposing connectable mobile device enclosure designed to be accessible and functional from the exterior of clothing without removal.

3. a system or kit component; press on fabric tracks containing the snap swivel points that adhere to other fabrics in a semi-permanent and washable bond that connect with the opposing connectable mobile device enclosure designed to be accessible and functional from the interior of clothing without removal.

4. a system or kit component; automobile steering wheel harness kit that enables a device within the mobile device enclosure of claim 1 to function as a mobile device navigation assistant while attached to a steering wheel.

5. a system or kit component; press on fabric tracks containing the snap swivel points that adhere to objects that connect with the opposing connectable mobile device enclosure designed to be accessible and functional from the object it was placed upon.

6. by design, dual zippers on the modular device enclosure of claim 1 are positioned to provide universal access to a device's ports.

7. the zipper line around the modular device enclosure of claim 1 is positioned and designed to provide pressure points for the functionality of a device's edge buttons and switches.
